(19) United States
(12) Patent Application Publication
(10) Pub. No.: US 2010/0293741 A1
(43) Pub. Date: Nov. 25, 2010

(54) Waste Collecting Device

(76) Inventor: John Ferris, Thunder Bay (CA)

Correspondence Address: ADE & COMPANY INC., 2157 Henderson Highway, WINNIPEG, MB, R2G1P9, CA

(21) Appl. No.: 12/742,101

(22) PCT Filed: Nov. 28, 2008
(86) PCT No.: PCT/CA08/02061

§ 371 Date: May 10, 2010

Related U.S. Application Data
(60) Provisional application No. 60/991,281, filed on Nov. 30, 2007.

(51) Int. Cl. A47L 5/00; A47L 9/00; A47L 7/00; A47L 9/10; H05B 3/00

(52) U.S. Cl. 15/339; 15/300.1; 15/347; 219/201

(57) ABSTRACT

An animal waste collecting device comprises a vacuum chamber in communication with an impeller arranged to draw air from the vacuum chamber through the exhaust port to produce a vacuum pressure in the vacuum chamber and a pickup up nozzle in communication with the vacuum chamber to collect waste with air drawn therethrough into the vacuum chamber by the vacuum pressure. A heater is supported in communication with the vacuum chamber to heat waste collected in the vacuum chamber for drying and/or incinerating the waste. A blower permits the dried or incinerated waste to be redirected from the vacuum chamber to a separate discharge chamber for subsequent disposal.

This application claims priority on U.S. provisional application Ser. No. 60/991,281, filed Nov. 30, 2007.

### FIELD OF THE INVENTION

The present invention relates to a device for collecting waste, for example animal or pet waste, using a vacuum pickup, and more particularly, the present invention relates to a device for collecting waste in which the collected waste can be dried and/or incinerated with heat prior to subsequent disposal.

### BACKGROUND

The desire to collect and dispose of animal waste is well known, including waste in the form of pet excrement, as well as waste in the form of geese droppings or other animal droppings which may litter lawns, public areas such as parks, or other outdoor areas including golf courses and the like.

Examples of prior art directed towards the collection of animal waste can be found in U.S. Pat. No. 5,661,873 belonging to Karet, U.S. Pat. No.7,226,098 belonging to Moreira and U.S. Pat. No. 7,003,846 belonging to Holtz. Animal waste collecting devices are described in each instance using a vacuum collection device, however once collected the waste still requires disposal in a conventional manner for example with household garbage. Accordingly these devices contribute to the continuing undesirable accumulation of landfill waste.

U.S. Pat. No. 5,481,780 belonging to Daneshvar discloses an unrelated vacuum system for controlling dust by providing a series of vacuum chambers in which a burner is provided for incinerating fine particle dust. The device is limited to use in incinerating fine particle dust while being large and cumbersome due to the multiple vacuum chambers required in separate modules so that the device cannot be readily transported and is unsatisfactory for portable use in collecting and disposing of animal waste at various outdoor locations for example.

### SUMMARY OF THE INVENTION

According to one aspect of the invention there is provided a waste collecting device comprising:

a vacuum chamber having an inlet port and an exhaust port;

an impeller arranged to draw air from the vacuum chamber through the exhaust port to produce a vacuum pressure in the vacuum chamber;

a pickup up nozzle in communication with the inlet port and arranged to collect waste with air drawn through the inlet port and into the vacuum chamber by the vacuum pressure in the vacuum chamber;

a heater supported in communication with the vacuum chamber and arranged to heat waste collected in the vacuum chamber.

By providing a heater in communication with the vacuum chamber in which the waste is collected, a compact collection device is described which is readily portable so as to be suitable for collection of pet waste. By heating the pet waste collected, harmful bacteria can be eliminated for sanitary purposes and the waste can be further dried or incinerated to produce finer powders suitable for disposal in gardens or outdoors in the form of ash or fertilizer to prevent further accumulation as landfill waste. The device can optionally be powered by a battery in a portable pickup mode and by grid power when plugged into a socket of a building subsequent to collection to produce a hotter and more extended drying and incineration period as may be desired to fully sanitize or reduce to dry powder the waste collected in the vacuum chamber.

An optional self cleaning mode of the device permits the dried material in the vacuum chamber once reduced to a powder or some particulate material, to be blown from the vacuum chamber by a suitable blower which discharges the dried material to a separate discharge chamber having a filtered exhaust thereon. Once the discharge chamber becomes full of dried particulate material, the material can be accessed in the discharge chamber for disposal. Use of a blower to self clean the vacuum chamber prevents contact between a user and any undried material in the vacuum chamber which may not be yet fully sanitized.

Preferably, the inlet port and the exhaust port communicate with the vacuum chamber adjacent a top end thereof.

Preferably, the heater is supported below the vacuum chamber and is arranged to direct heat upwardly into the vacuum chamber.

There may also be provided a grinder supported in the vacuum chamber which is arranged to reduce waste collected in the vacuum chamber into smaller particles. The grinder may comprise at least one blade or an auger supported for rotation about an upright axis.

In some embodiments, an air source, for example a blower, is also provided below the vacuum chamber and adjacent the heater so as to be arranged to direct heat from the heater directly into the vacuum chamber.

The air source may also be arranged to direct waste collected in the vacuum chamber into a separate discharge chamber subsequent to drying by the heater. The discharge chamber is preferably fixed on a common supporting structure relative to the vacuum chamber, the heater and the air source or blower.

The discharge chamber may include an inlet arranged to receive airflow from the vacuum chamber and an outlet including a filter which is arranged to filter particles and odours from escaping the discharge chamber.

Preferably an access panel on the discharge chamber provides access to the contents of the discharge chamber for disposal.

There may also be provided an odour absorbing filter spanning the exhaust port of the vacuum chamber.

A timer may be used to operate the heater for a prescribed period of time upon actuation.

The heater may be operated on battery power, or there may be provided an electrical connector on the heater arranged for receiving electrical power from a building electrical socket on grid power.

The grinder and the impeller may be operable together for a prescribed period of time using a timer, upon actuation using power from a battery.

The inlet of the vacuum chamber may include a large particle debris screen to prevent entry of dangerous materials into the vacuum chamber.

In the illustrated embodiment, the vacuum chamber, the impeller and the heater are supported within a common housing which may be arranged to be supported on a back of a person by a suitable harness. Preferably the common housing is insulated.

The impeller and the exhaust port are preferably supported above the vacuum chamber while the heater is supported below the vacuum chamber within the common housing.

When there is provided a discharge chamber within the common housing below the heater, the blower adjacent the heater is preferably arranged to direct waste collected in the vacuum chamber into the discharge chamber once the waste material has been reduced to smaller and dryer particles.

The pickup nozzle may be operable between a first configuration in which an open free end of the nozzle is arranged to collect waste into the vacuum chamber by operation of the impeller and a second configuration in which the nozzle communicates with the discharge chamber to discharge material from the vacuum chamber to the discharge chamber by operation of the blower.

When the heater comprises an electrical resistance heater, there may be provided an electrical connector on the heater arranged for connection to grid power.

When the heater comprises a combustible fuel fired heater, there may be provided a combustible fuel source commonly supported with the vacuum chamber.

There may be provided a manifold in communication between the heater and the vacuum chamber and an air source comprising a tank of compressed air commonly supported with the vacuum chamber in which the air source is arranged to direct air flow across the heater from the tank to the vacuum chamber.

When there is provided a frame supported on wheels, the vacuum chamber and the heater are preferably commonly supported on the frame so as to be arranged for rolling movement along the ground.

There may be provided a pickup member rotatably supported on the frame. The pickup member preferably comprises paddles supported for rotation about a horizontal pick up axis adjacent the ground so as to be arranged to collect waste from the ground. The pickup nozzle is preferably supported in communication with the pickup member so as to be arranged to draw waste collected by the pickup member into the vacuum chamber.

Some embodiments of the invention will now be described in conjunction with the accompanying drawings in which:

### BRIEF DESCRIPTION OF THE DRAWINGS

FIG. 1 is a perspective view of a first embodiment of the waste collecting device.

FIG. 2 is a schematic illustration of the various components of the device according to FIG. 1.

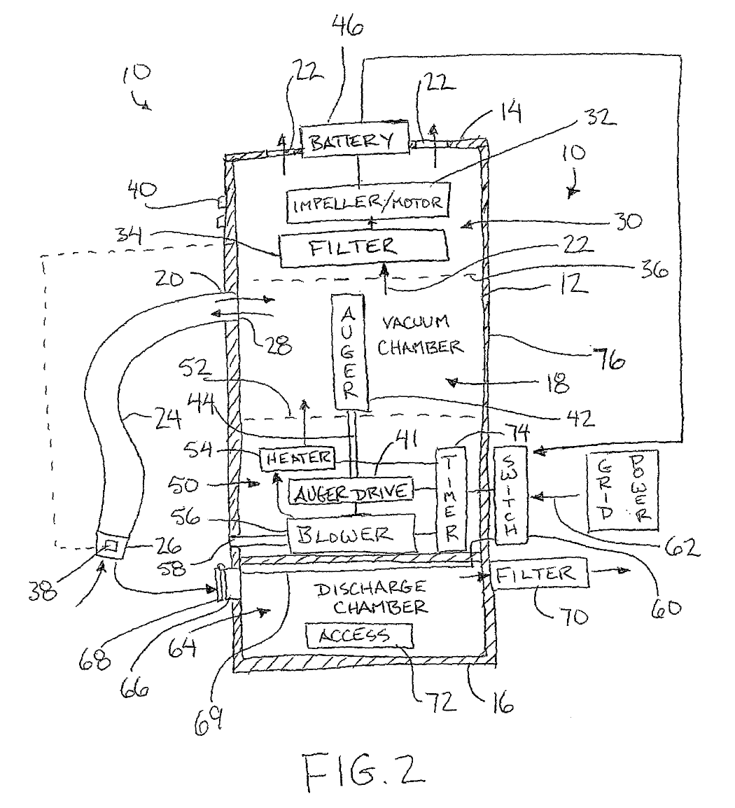

FIG. 3 is a perspective view of a second embodiment of the waste collective device.

FIG. 4 is a perspective view of a third embodiment of the waste collective device.

FIG. 5 is a perspective view of a fourth embodiment of the waste collective device.

FIG. 6 is a perspective view of a fifth embodiment of the waste collective device.

In the drawings like characters of reference indicate corresponding parts in the different figures.

### DETAILED DESCRIPTION

Referring to the accompanying figures there is illustrated a waste collecting device generally indicated by reference numeral 10. The device 10 comprises a portable housing which is particularly suited for collection and subsequent disposal of pet or animal waste. Although various embodiments of the waste collecting device are shown in the accompanying figures, the common features of the various embodiments will first be described herein.

The device 10 includes a central vacuum chamber 18 within the housing 12 having an inlet 20 and an exhaust outlet 22. The vacuum chamber 18 is centrally located between the top and bottom ends of the housing. The inlet 20 communicates through a side wall of the housing to the vacuum chamber 18 adjacent a top end of the vacuum chamber. The inlet 20 is directed or oriented in a generally tangential or circumferential direction at its point of communication with the interior of the vacuum chamber to encourage flow entering the vacuum chamber 18 through the inlet to be directed in a circumferential or periphery direction about the vacuum chamber. The exhaust 20 is provided centrally at a top end of the vacuum chamber 18.

A pickup hose 24 is provided for communication between the inlet 20 of the vacuum chamber and a nozzle 26 supported at the free end of the pickup hose 24. In a pickup mode of the device, the nozzle 26 can be supported in a hand of the user in some embodiments for directing the open end of the nozzle 26 at waste to be collected into the vacuum chamber 18.

A screen 28 is provided at the inlet port 20 of the vacuum chamber for blocking the entry of larger debris into the chamber, for example batteries and the like. The hose 24 comprises a flexible tubular member having a low friction coating along an inner surface thereof, for example Teflon and the like to prevent the accumulation of debris along the inner walls of the hose 24. The hose 24 is also insulated.

A motor chamber 30 is provided above the vacuum chamber within the housing 12 so as to be situated adjacent a top end of the housing. The motor chamber 30 houses an impeller 32 which when operated produces sufficient airflow to be drawn from the vacuum chamber through the exhaust port of the vacuum chamber to produce a vacuum pressure within the vacuum chamber 18. This vacuum pressure in turn induces air to be drawn into the vacuum chamber through the pickup hose and inlet 20 so that waste material can be collected with the airflow into the vacuum chamber at the free end opening of the nozzle 26.

The airflow drawn out of the vacuum chamber 18 by the impeller 32 is discharged through a suitable filter 34 adjacent the top end of the housing. The filter includes a particle filter for preventing escape of dust as well as charcoal filter for escape of odours from the vacuum chamber. A particle screen 36 is provided which spans the top end of the vacuum chamber 18 in series between the vacuum chamber and the impeller in the motor chamber 30 for preventing escape of larger particles from the vacuum chamber through the vacuum exhaust.

The motor which drives the vacuum impeller 32 includes a power switch 38 so that an operator can readily select operation of the vacuum impeller. Indicators 40 are provided on the outside of the housing at the motor chamber 30 to indicate if the vacuum is on or off.

A high powered compact battery 46 is also supported in the motor chamber 30 for providing power to the motor of the vacuum impeller 32. The batteries 46 which power the components of the motor chamber 30 are readily rechargeable and/or replaceable.

A heat chamber 50 is provided below the vacuum chamber for generating heat therein and directing the heat upwardly into the vacuum chamber through a screen 52 acting as a divider spanning generally horizontally between the heat chamber 50 therebelow and the vacuum chamber 18 thereabove.

A suitable heater 54 is supported in communication with the heat chamber 50. The heater 54 is capable of generating sufficient heat to kill bacteria in the vacuum chamber, for initially drying the waste materials in the vacuum chamber and for subsequently incinerating the waste materials when heated for longer cycles. A heater capable of generating in the order of 5700 BTU's is suitable for use in the present invention.

An air source 56 of air flow under pressure is also provided in association with the heat chamber 50 to direct air to be heated across the heater 54 and through the screen 52 upwardly into the vacuum chamber.

A grinder 42 is also provided in the heat chamber 50 in the form of at least one blade supported for rotation about a vertical shaft 44 and communicates with a respective drive 41 located therebelow. The grinder 42 is driven by the drive 41 to drive rotation of the shaft and the blades fixed thereon for grinding the waste material collected in the vacuum chamber into finer particles and powders.

Actuation of the heater 54, the air source 56, and the grinder 42 are accomplished together through a suitable actuation switch 60 in a side wall of the housing which starts a timer 74. The timer 74 operates the heater 54, the air source 56, and the grinder 42 for a preliminary cycle of prescribed duration, for example approximately 50 seconds, under power from the batter 46.

A discharge chamber 64 is commonly supported in fixed relation to the vacuum chamber. The discharge chamber 64 includes an inlet 66 in a side wall of the housing for receiving dry, ground material from the vacuum chamber 18 in a cleaning mode of the device. The inlet includes a cover 68 which is suitable for enclosing the inlet when not in use. The cover is hinged on the inlet and biased to a closed position.

In the cleaning mode, the nozzle 26 of the pickup hose is arranged to be inserted into the inlet 66 of the discharge chamber while the inlet hose 24 opposite the nozzle remains connected to the inlet 20 of the vacuum chamber. The nozzle 26 is configured for mating connection with the inlet 66 through a wedge or tapered shape which is frictionally engaged within the inlet 66 and which may be further selectively secured therein by a twist lock mechanism.

The inlet 66 of the discharge chamber may include a switch connection 69 to the switch 60 which operates the grinder, the air source and the heater for automatically initiating the preliminary cycle thereof when the nozzle is inserted into the inlet 66.

The discharge chamber 64 further includes an exhaust 70 also in a side wall of the housing. The exhaust includes a suitable odour filter and particle filter spanning thereacross to prevent exhausting of fine particles and odours from the discharge chamber to the surrounding atmosphere. An access panel 72 in the form of a door or drawer is also provided in the discharge chamber 64 in the side wall of the housing to provide access for removing dried particulate waste from the discharge chamber.

In use, the battery 46 of the vacuum is initially charged with sufficient power for several vacuum cycles and optionally several preliminary cycles of the grinder, heater and air source to be performed, each in the order of fifty seconds for example. When it is desired to minimize weight, the battery is suitably sized primarily for operating the vacuum for shorter durations and subsequent heating and grinding is accomplished later when connected to grid power.

The user then supports the housing for portability so that the user can follow a pet animal outdoors or can roam about collecting previously deposited animal waste, for example from geese and the like.

Whenever required, the vacuum is actuated to collect animal waste from the ground. The vacuum cycle causes the waste material to be drawn into the vacuum chamber where it is subsequently broken up into smaller particles by the grinder 42. A preliminary heating, drying and grinding cycle can also be initiated in which the blower draws air through its respective inlet to be directed over the heater and into the vacuum chamber for heating and drying the waste therein. The blower air directed to the vacuum chamber is typically exhausted through the hose 24 into the discharge chamber when operating the preliminary cycle.

When the user returns to a building with grid power, the device can be plugged into the electrical power from the building using the socket 62. In this position a full and more extended heating, grinding and drying cycle can be executed by generating sufficient heat with the heater and directing the heat into the vacuum chamber with the air source 56 to fully dry and/or incinerate the waste material in the vacuum chamber 18. The air source, grinder and heater are operated together by the respective power switch 60 which actuates the timer 74 which in turn actuates the blower, grinder and heater for a prescribed period of time sufficient to reduce the waste materials to the desired degree of fine incinerated particles. The extended cycle of the heater, grinder and air source operation is typically in the order of 3 to 4 minutes in duration.

When the materials have been sufficiently reduced by drying or incineration, further actuation of the air source directs finer dried particles of material through the pickup hose 24 into the discharge chamber, in the self cleaning mode, where the airflow is filtered prior to exiting the exhaust of the discharge chamber. The positioning of the nozzle within the inlet of the discharge chamber accomplishes the self cleaning mode of operation to clean the vacuum chamber of dried and incinerated waste. After several cycles the accumulated waste in the discharge chamber can be disposed of through access to the chamber at the access panel 72.

Insulation 76 is provided about the cylindrical walls of the housing for surrounding the heat chamber and the vacuum chamber and for insulating the heat chamber and the vacuum chamber relative to the surrounding environment during heating, drying and incineration cycles of the device 10.

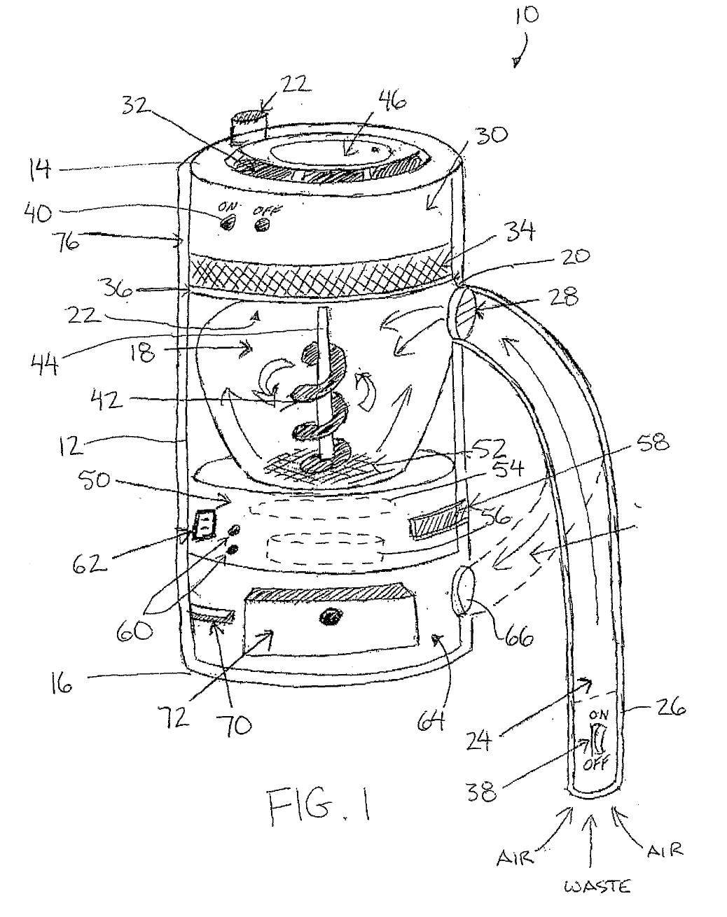

Turning now more particularly to the embodiment of FIG. 1, the device 10 is provided with a suitable harness attached to the housing 12 which is arranged to support the housing on a back of a user using shoulder straps and the like for readily transporting the device.

The housing 12 in this instance is generally elongate in a vertical direction between the top end 14 and the bottom end 16 of the device. The housing is generally cylindrical in shape. The discharge chamber 64 is supported below the heat chamber at the bottom end of the housing 12.

The power switch 38 for the motor which drives the vacuum impeller 32 is supported on the nozzle 26 for ready activation of the vacuum impeller to collect waste through the nozzle when the housing is supported on the back of a person and the nozzle is held in the hand of the person. The vacuum is typically actuated using the switch at the nozzle 26 held in the hand of the user to collect animal waste from the ground.

The heater 54 according to FIG. 1 takes the form of electrical resistance coils supported within the heat chamber 50 to be powered by an electrical battery within the housing.

The air source 56 according to FIG. 1 comprises a blower in the form of a rotating fan or impeller for directing air in a flow across the heater 54, and through the screen 52 into the heat chamber 50. The blower 56 draws air from an inlet 58 in a side wall of the housing 12 at the heat chamber 50.

The grinder 42 of FIG. 1 comprises an auger supported for rotation about a vertical shaft 44 of the auger which spans the height of the vacuum chamber and communicates with the drive 41 located in the heat chamber 30. The drive 41 of the grinder 42 is driven by the blower rotation to drive rotation of the shaft and the auger flighting fixed thereon.

Adjacent the actuation switch 60 there is also provided an electrical socket 62 which can be used to plug in the heater and the blower to grid power through a building socket for supplementing battery power of the device. Grid power is used for actuating the heater and blower for extended periods beyond the preliminary cycle to generate sufficient heat for fully drying or incinerating the waste material.

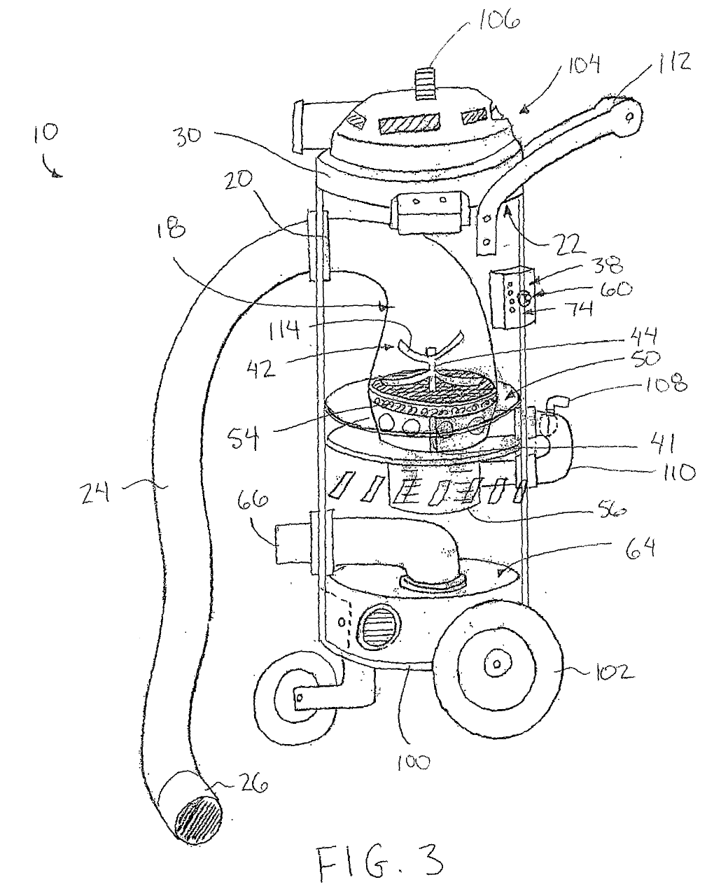

Turning now to the embodiments of FIGS. 3 through 6, the device 10 is provided with a frame 100 supported on wheels 102 for rolling movement along the ground. The frame commonly supports the vacuum chamber 18, the motor chamber 30, the heat chamber 50, the air source 56, and the discharge chamber 64 thereon in fixed relation to one another. In each instance the vacuum chamber is provided with a lid or cover 104 enclosing the top end thereof and secured to the vacuum chamber walls by suitable latches such that the cover 104 can be readily separated from the housing walls of the vacuum chamber for access to the vacuum chamber as may be required.

The impeller 32 and motor for driving the impeller in the motor chamber 30 are housed within the cover at the top end of the vacuum chamber for communication of the impeller with the outlet of the vacuum chamber to draw air out of the vacuum chamber and produce a vacuum pressure therein. A suitable handle 106 is provided on the top side of the cover 104 for ease of removal thereof.

The housing of the vacuum chamber is fully insulated and the interior is lined with a non-stick coating, for example Teflon. The Teflon coating also lines the discharge chamber 64, the heat chamber 50 and the pickup hose 24.

In each instance, the pickup hose 24 is operable in two modes similar to the previous embodiment described above in which the pickup hose permits material and waste to be collected into the vacuum chamber with the impeller operating in a first collection mode. Alternatively the impeller can be shutoff and the grinder and heater operated for drawing and breaking up the waste material collected in the vacuum chamber. When the material is ready for subsequent disposal from the vacuum chamber, the air source 56 is operated to discharge the collected material in the vacuum chamber back through the pickup hose 24 which is then connected to the inlet of the discharge chamber 64 in the second mode for discharging the dried and incinerated contents of the vacuum chamber. Furthermore in the embodiments of FIGS. 3 through 6, an airflow valve 108 is provided in series with a manifold 110 communicating from the air source 56 into the vacuum chamber across the heater 54 for controlling the airflow rate across the heater.

Turning now to the embodiment of FIG. 3, the vacuum chamber is arranged in an upright configuration to be positioned on the frame 100 directly above the heat chamber 50 which is in turn positioned above the discharge chamber 64 within a common cylindrical housing. In this configuration the common housing is elongate in between the top and bottom ends of the device and is generally cylindrical in shape similar to the first embodiment. All of the control elements including the power switch 38, the actuation switch 60 and the timer 74 are commonly located for ease of access on the side of the common housing adjacent the top end.

A suitable handle 112 is provided at the top end of the common housing to be located at a comfortable height for grasping in the hands of a user standing beside the device for pushing the device for rolling movement on the wheels 102. In the illustrated embodiment, the overall diameter of the cylindrical common housing is approximately 12 inches such that the vacuum chamber, the heating chamber 50, the discharge chamber 64, and any dividing members therebetween all span substantially the full 12 inch diameter of the housing. The overall height of the unit is typically in the order of 36 inches in the embodiment of FIG. 3 with the discharge chamber 64 occupying the lower six inches of the unit while the vacuum chamber occupies the majority of the overall height adjacent the top end of the device 10. A 2.5 inch diameter hose is typically suitable.

As shown in the embodiments of FIGS. 3 through 6, the grinder 42 may differ from the previous embodiment in that a plurality of cutting blades 114 are provided which extend radailly outward from a common shaft of the grinder for rotation therewith about a vertical axis within the bottom end of the vacuum chamber. The blades may comprise lower blades which are longer in the order of 5¾ of an inch in length in the radial direction from the shaft and shorter blades thereabove which may be in the order of 4 inches in length in a radial direction from the shaft. The lower blades preferably extend downward to the outer ends thereof which are very close to the screen at the bottom of the vacuum chamber in communication with the heat chamber while the upper blades are preferably spaced above the lower blades at a mid-height of the vacuum chamber so as to be central within the chamber.

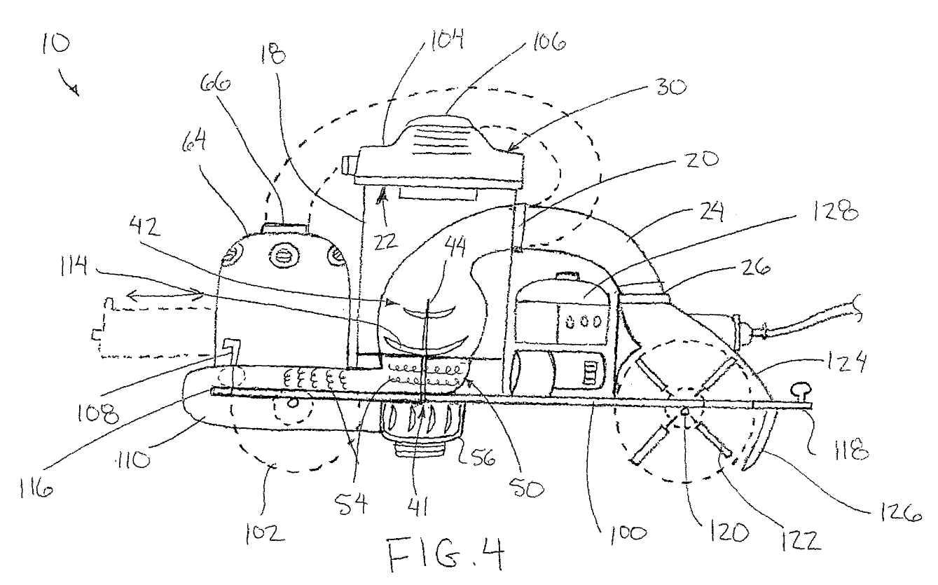

Turning now more particularly to the embodiments of FIGS. 4 through 6, the frame 100 in this instance is arranged to be supported low to the ground on the wheels 102 which are provided at a rear discharge end 116 of the frame while the front pickup end 118 of the frame is supported for rolling movement along the ground on a pickup member 120 which is driven to rotate about a horizontal axis extending laterally across the front pickup end 118 of the frame.

The pickup member comprises a horizontal shaft supporting a plurality of paddles 122 thereon which extend radially outward for rotation against the ground to collect waste material from the ground. A pickup housing 124 surrounds the pickup member 120 and is open at the bottom end thereof for access of the waste material on the ground up into the pickup member. A top end of the pickup housing 124 is tapered upwardly and inwardly for connection to the nozzle at the end of the pickup hose 24.

The nozzle 26 in this instance is arranged for selective detachment from the pickup housing 124 in the first mode to be connected to the inlet of the discharge chamber 64 in the second mode as in the previous embodiments described above. A front guard 126 is provided in the form of a panel which depends downwardly from the front end of the pickup housing 124 to prevent access of large objects to the front pickup member 120. The paddles of the pickup member are arranged to extend downwardly beyond the bottom edge of the front guard so that a clearance is provided between the bottom end of the front guard and the ground to accommodate waste material to be collected therethrough.

Also in the embodiments of FIGS. 4 through 6, an internal combustion engine 128 which combusts fuel therein is mounted on the frame rearward of the pickup member 120 and forwardly of the centrally located vacuum chamber. The motor 128 can be arranged to directly drive the impeller 32, the pickup member 120, the grinder 42, or the blower air source 56 when provided, or alternatively the driven components are driven by respective electrical motors receiving power from a battery, which is in turn charged by a generator driven by the motor 128.

Furthermore in the embodiment of FIGS. 4 through 6, the discharge chamber 64 is provided at the rear discharge end 116 of the frame 100. The air source 56 can be provided below the vacuum chamber or at the rear end adjacent the discharge chamber 64. In either instance the air source 56 communicates through the manifold 110 in a generally horizontal orientation to the heat chamber 50 directly below the vacuum chamber and in communication therewith through a suitable screen member as described above. Air is controllably released by the air source 56 in a pressurized airflow by action of the controlling elements of the device as required to pass the airflow over the heater and into the vacuum chamber for drying and incinerating the waste material.

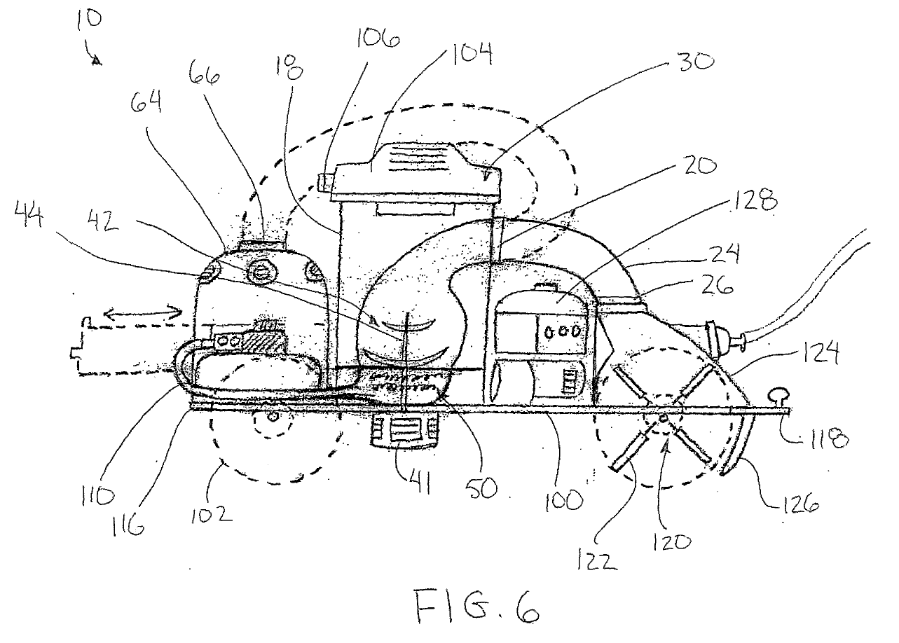

In the embodiment of FIG. 4 and FIG. 6, the heater 54 comprises electric heating coils similar to the previous embodiments of FIGS. 1 and 3. The heating coils are electrically heated so that the airflow from the air source 56 into the vacuum chamber is heated as it passes over the coils prior to entering the vacuum chamber.

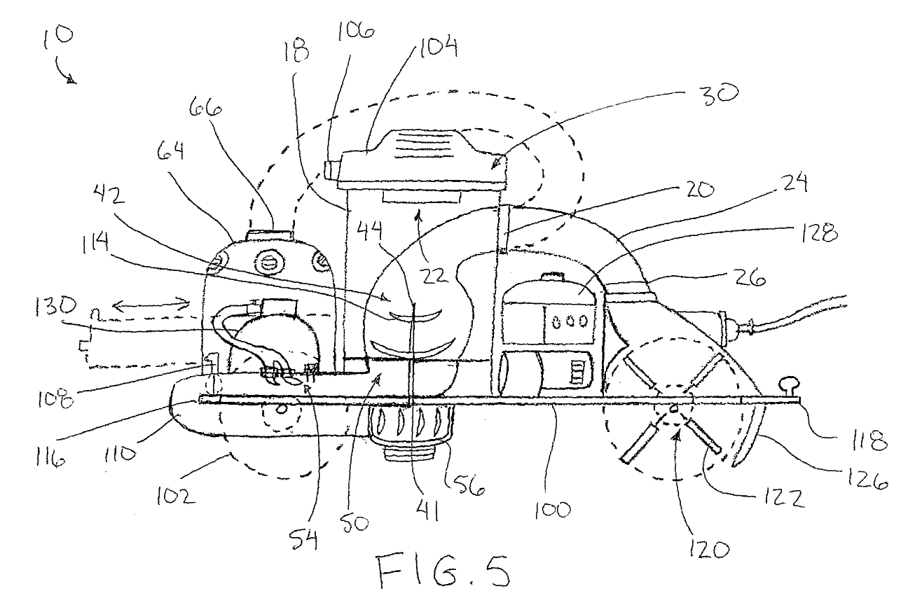

Furthermore in FIG. 4 and FIG. 5, the air source 56 comprises a blower similar to the previous embodiments of FIGS. 1 and 3 in which the blower is driven to rotate about the same vertical axis as the grinder 42 to be commonly driven to rotate together. The blower generates an airflow from external ports in the housing to the manifold 110 which gathers heat from the heater 54 to distribute the heat into the vacuum chamber for drying and incinerating the waste.

The embodiment of FIG. 5 differs from the previous embodiments in that the heater 54 comprises a source of combustible fuel comprising a fuel tank 130 is supported on the rear end of the frame. The tank 130 delivers fuel to a suitable burner which defines the heater 54 which is located within the manifold 110 to be situated within the airflow from the air source 56 to the vacuum chamber.

Turning now to the embodiment of FIG. 6, the heater again comprises electrical resistance coils, however the air source 56 in this instance comprises a compressed air tank 132 supported on the rear end of the frame 100 to controllably release an airflow from the tank through the manifold to the vacuum chamber so that the airflow is directed across the heater 54 as in previous embodiments.

The device 10 of the present invention is a convenient portable appliance for pick up and destroying animal waste or organic matter.

The device 10, combines vacuum cleaner, mincer/grinder and incinerator technology in disposing of animal waste or organic garbage. Some embodiments can be small enough for personal use and can be comfortably toted while larger versions are suitable for industrial/commercial or grounds-maintenance use as well.

This device can be heated and air flow powered with a variety of different methods, for example propane, kerosene, gasoline powered engine, AC, AC/DC, air compressor and powered by a generator or modified to the pulling unit as the power source.

The process begins with a vacuum function taking up the waste, through a flexible plastic/Teflon tube. The vacuum can be powered by a high battery powered-operated motor which also the incinerator and fan blower will be powered by electricity for cleaning and sterilizing the unit. A mincer/grinder also engages after the vacuum has been turned off, and the incinerator chamber begins to heat and mince the waste. The shape of the device is a canister which houses the vacuum motor and charcoal-filtered air intake at the top; hose intake socket, collection space and grinder mid-section; incinerator motor in a separate chamber below, with a waste dispenser drawer for ash or fertilizer at the bottom or to the side of the unit.

The unit can be self-sterilizing through heat and with the fan blower, and the parts can be detached for further cleaning.

The device 10 is suited as an appliance for clean, environment-friendly, “hands-off” and convenient disposal of animal waste and organic matter. It could eliminate the common use of plastic bags for dog-walking cleanup and organic matter going to landfill sites.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A waste collecting device comprising:
a vacuum chamber having an inlet port and an exhaust port;
an impeller arranged to draw air from the vacuum chamber through the exhaust port to produce a vacuum pressure in the vacuum chamber;
a pickup up nozzle in communication with the inlet port and arranged to collect waste with air drawn through the inlet port and into the vacuum chamber by the vacuum pressure in the vacuum chamber;
a heater supported in communication with the vacuum chamber and arranged to heat waste collected in the vacuum chamber.

2. The device according to claim 1 wherein the inlet port and the exhaust port communicate with the vacuum chamber adjacent a top end thereof.

3. The device according to claim 1 wherein the heater is supported below the vacuum chamber and is arranged to direct heat upwardly into the vacuum chamber.

4. The device according to claim 1 wherein there is provided a blower adjacent the heater and arranged to direct heat from the heater directly into the vacuum chamber.

5. The device according to claim 1 wherein there is provided a grinder supported in the vacuum chamber and arranged to reduce waste collected in the vacuum chamber into smaller particles.

6. The device according to claim 5 wherein the grinder comprises at least one cutting blade arranged for rotation about an upright axis.

7. The device according to claim 1 wherein there is provided a blower arranged to direct waste collected in the vacuum chamber into a separate discharge chamber subsequent to drying by the heater.

8. The device according to claim 7 wherein the discharge chamber is commonly supported with the vacuum chamber so as to be fixed relative to one another.

9. The device according to claim 7 wherein the discharge chamber includes an inlet arranged to receive airflow from the vacuum chamber and an outlet including a filter which is arranged to filter particles and odours from escaping the discharge chamber.

10. The device according to claim 7 wherein there is provided an access panel on the discharge chamber for accessing contents of the chamber.

11. (canceled)

12. The device according to claim 1 wherein there is provided a timer arranged to operate the heater for a prescribed period of time upon actuation.

13. The device according to claim 1 wherein there is provided a grinder supported in the vacuum chamber which is arranged to reduce waste collected in the vacuum chamber into smaller particles, the grinder and the impeller being operable together for a prescribed period of time upon actuation.

14. (canceled)

15. (canceled)

16. The device according to claim 1 wherein the impeller and the exhaust port are supported above the vacuum chamber and the heater is supported below the vacuum chamber within a common housing.

17. The device according to claim 16 wherein there is provided a discharge chamber commonly supported in fixed relation to the heater and a blower adjacent the heater arranged to direct waste collected in the vacuum chamber into the discharge chamber once the waste material has been reduced to smaller and dryer particles.

18. The device according to claim 1 wherein there is provided a source of air under pressure arranged to direct waste collected in the vacuum chamber into a separate discharge chamber subsequent to drying by the heater and wherein the pickup nozzle is operable between a first configuration in which an open free end of the nozzle is arranged to collect waste into the vacuum chamber by operation of the impeller and a second configuration in which the nozzle communicates with the discharge chamber to discharge material from the inlet port of the vacuum chamber to the discharge chamber by the source of air under pressure.

19. (canceled)

20. (canceled)

21. The device according to claim 1 wherein there is provided a manifold in communication between the heater and the vacuum chamber and an air source comprising a tank of compressed air commonly supported with the vacuum chamber, the air source being arranged to direct air flow across the heater from the tank to the vacuum chamber.

22. The device according to claim 1 wherein there is provided a frame supported on wheels, the vacuum chamber and the heater being commonly supported on the frame so as to be arranged for rolling movement along the ground.

23. The device according to claim 22 wherein there is provided a pickup member rotatably supported on the frame, the pickup member comprising paddles supported for rotation about a horizontal pick up axis adjacent the ground so as to be arranged to collect waste from the ground, the pickup nozzle being supported in communication with the pickup member so as to be arranged to draw waste collected by the pickup member into the vacuum chamber.

24. The device according to claim 1 wherein the vacuum chamber, the impeller and the heater are supported within a common housing and wherein there is provided a harness arranged to support the common housing on a back of a person.
